(19) United States
(12) Patent Application Publication
(10) Pub. No.: US 2010/0133150 A1
(43) Pub. Date: Jun. 3, 2010

(54) Use of A Fluorocarbon Polymer as A Surface Of A Vessel or Conduit Used In A Paraffinic Froth Treatment Process For Reducing Fouling

(76) Inventors: Tapantosh Chakrabarty, Calgary (CA); Ken Sury, Calgary (CA); Larry Lawlor, Camlachie (CA); Mohsen Yeganeh, Hillsborough, NJ (US)

Correspondence Address: EXXONMOBIL UPSTREAM RESEARCH COMPANY, P.O. Box 2189, (CORP-URC-SW 359), Houston, TX, 77252-2189, US

(21) Appl. No.: 12/598,862

(22) PCT Filed: Jul. 2, 2008
(86) PCT No.: PCT/US08/08343

§ 371 Date: Nov. 4, 2009

(30) Foreign Application Priority Data
Jul. 20, 2007 (CA) 2594205

(51) Int. Cl. B32B 1/08; B05D 7/22; B32B 37/00; C10G 1/04

(52) U.S. Cl. 208/390; 428/36.91; 427/230; 156/294

(57) ABSTRACT

A use of a fluorocarbon polymer as a surface of a vessel or conduit in a paraffinic froth treatment (PFT) process, for reducing fouling. The foulant comprises asphaltenes. The surface has an average water contact angle of greater than 90 degrees, a standard deviation of water contact angles divided by the average water contact angle of less than 0.1, and impurities of less than 1000 ppmw. The fluorocarbon polymer may be a polytetrafluoroethylene (PTFE)-based polymer. The surface may be substantially free of colorants, fillers, and plasticizers.

### CROSS-REFERENCE TO RELATED APPLICATIONS

This application claims priority from Canadian Patent Application number 2,594,205 which was filed on 20 Jul. 2007, which is incorporated herein by reference.

### FIELD OF THE INVENTION

The present invention relates generally to reducing fouling on a surface in a paraffinic froth treatment process.

### BACKGROUND OF THE INVENTION

In the field of bitumen extraction from mined oil sands, solvent froth treatment may be used. Generally, oil sands are mined, bitumen is extracted from the sands using water, and bitumen is separated as a froth comprising bitumen, water, solids and air. In certain froth treatment processes, naphtha is used as the solvent to dilute the froth before separating the product bitumen by centrifugation. In other cases, paraffinic froth treatment (PFT) is used where a paraffinic solvent, for instance a mixture of iso-pentane and n-pentane, is used to dilute the froth before separating the product bitumen by gravity. Where a paraffinic solvent is used, a portion of the asphaltenes in the bitumen is also rejected by design in the PFT process thus achieving solid and water levels that are lower than those in the naphtha-based froth treatment (NFT) process. A PFT process typically employs at least three units: a froth separation unit (FSU), a solvent recovery unit (SRU) and a tailings solvent recovery unit (TSRU). An example of a PFT process is described in the detailed description. During a PFT process, foulant, which comprises asphaltenes, may form and build on one or more surfaces of the FSU or other vessel or conduit used in the PFT process. The foulant builds up to a thickness at which it interferes with the normal operation of the process. The process unit should then be cleaned. Reducing fouling on the surfaces of the FSU or other vessel or conduit in the PFT process is desirable.

Canadian Patent Application No. 2,502,635 (published Sep. 26, 2006) relates to reducing fouling in a thermal process for treating feed streams comprising naphtha, pyrolysis oils or a mixture thereof. The feed stream has a combined olefinic content from 10 to 50 weight percent, the balance being inert hydrocarbons, at a temperature from 100° C. to 300° C. The fouling reduction is achieved by decreasing the amount of carbon steel in the apparatus contacting the feed stream and increasing the amount of stainless steel. The surface roughness of the steel is said to be typically less than 25 μm or less than 20 μm.

### SUMMARY OF THE INVENTION

Generally, the present invention provides a foulant reducing surface for use in a paraffinic froth treatment (PFT) process. The surface may be used on the inside of a vessel or conduit. The foulant comprises asphaltenes. The properties of the surface are such that less foulant accumulates on the surface than on conventional surfaces.

In a first aspect, the present invention provides a use of a fluorocarbon polymer as a surface of a vessel or conduit in a paraffinic froth treatment (PFT) process, for reducing fouling, the foulant comprising asphaltenes, wherein the surface has: an average water contact angle of greater than 90 degrees; a standard deviation of water contact angles divided by the average water contact angle of less than 0.1; and impurities of less than 1000 parts per million weight (ppmw). In certain embodiments, the following features may be present.

The average water contact angle may be greater than 100 degrees, greater than 110 degrees, or greater than 115 degrees.

The standard deviation of water contact angles divided by the average water contact angle may be less than 0.05, or less than 0.03.

Less than 100 ppmw impurities or less than 10 ppmw impurities may be present.

The fluorocarbon polymer may comprise a polytetrafluoroethylene (PTFE)-based polymer, wherein a PTFE-based polymer is a homopolymer of TFE (tetrafluoroethylene) or a copolymer of TFE with one or more comonomers comprising at least one ethylene type unsaturation. The comonomer content may be less than 2 percent by weight or less than 1 percent by weight. The comonomers may comprise: a C₃-C₈ perfluoroolefin; a C₂-C₈ chloro-; bromo- and/or iodo-fluoroolefin; a (per)fluoroalkylvinylether of formula FE, wherein R_{f} is a C₁-C₆ (per)fluoroalkyl, a (per)fluoro-oxyalkyvinylether of formula CF₂═CFOX, wherein X is a C₁-C₂ alkyl, a C₁-C₁₂ oxyalkyl, or a C₁-C₁₂ (per)fluoro-oxyalkyl having one or more ether groups.

The fluorocarbon polymer may be PFA (perfluoroalkoxy), FEP (fluorinated ethylene prolylene), ETFE (ethylene tetrafluoroethylene), ECTFE (ethylene chlorotrifluoroethylene), PVDF (polyvinylidene fluoride), or PCTFE (polychlorotrifluoroethylene).

The fluorocarbon polymer may be a polymer in accordance with ASTM D4894-98a of Type I, II, III, or IV. The fluorocarbon polymer may be a polymer in accordance with ASTM D 4894-98a of Type IV, Grade 2, or ASTM D 4895-04.

The fluorocarbon polymer may be a fluoroelastomer or a tetrafluoroelastomer.

The surface may have a surface roughness of less than 0.5 μm.

The surface may be substantially free of colorants, fillers, and plasticizers.

The fluorocarbon polymer may be affixed to, adhered to, abutted against, or mated with, an inside of the vessel or conduit.

The fluorocarbon polymer may be made by isostatic molding.

The foulant may comprise water, paraffinic solvent, inorganics, and non-volatile hydrocarbons comprising asphaltenes. The foulant may comprise 5-80 percent water and paraffinic solvent, 1-80 percent inorganics, 1-90 percent non-volatile hydrocarbons comprising asphaltenes, all by weight. The foulant may comprise about 46-50 percent water and paraffinic solvent, about 24-46 percent inorganics, and about 14-26 percent non-volatile hydrocarbons comprising asphaltenes, all by weight. The foulant may comprise between 7 and 40 percent asphaltenes, by weight. The inorganics may comprise quartz, alumino-silicates, carbonates, FeₓS_{y}, where x is from 1 to 2 and y is from 1 to 3, and titanium-rich minerals. A major amount by number of the inorganics may be present in particulates of less than 1 μm in size. The vessel may be a froth separation unit (FSU) used in the PFT process and the surface may be a launder area of the FSU.

In another aspect, the present invention provides a process for creating a fouling reducing surface of a vessel or conduit for use in a paraffinic froth treatment (PFT) process, the foulant comprising asphaltenes, the process comprising: forming a fluorocarbon polymer; and at least partially covering an inside of the vessel or conduit with the formed polymer; wherein the surface has: an average water contact angle of greater than 90 degrees; a standard deviation of water contact angles divided by the average water contact angle of less than 0.1; and impurities of less than 1000 ppmw. In certain embodiments, the following features may be present.

The step of at least partially covering an inside of the vessel or conduit with the polymer may comprise adhering or affixing the polymer to, or abutting the polymer against, the inside of the vessel of conduit, or may comprise mating a plurality of pieces of polymer with mating members on the inside of the vessel of conduit.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic of a PFT process;

FIGS. 2a and 2b are scanning electron microscope (SEM) photographs of PFT foulants;

FIGS. 3a and 3b are photographs of control carbon steel, cement and ceramic coupons in FSU-1, before (3a) and after (3b) exposure, as described in Comparative Example A;

FIGS. 4a and 4b are photographs of control carbon steel, ceramic (×3) and cement materials in FSU-2, before (4a) and after (4b) exposure, as described in Comparative Example B;

FIGS. 5a and 5b are photographs of a control carbon steel coupon in FSU-1 (5a) and FSU-2 (5b), as described in Comparative Example B;

FIG. 6 is a graph showing normalized weight gain of various samples of conventional cement and ceramic coupons in FSU-1 and FSU-2, as described in Comparative Examples A and B;

FIG. 7 is a graph showing normalized weight gain of various samples of conventional cement and ceramic coupons in FSU-1 and FSU-2, as described in Comparative Example C;

FIGS. 8 to 12 are photographs of Teflon®-coated carbon steel, DLC (Diamond-like-carbon), FRP (Fibre-Reinforced Plastic), electropolished steel, and Ni—P plated 5-Cr coupons, respectively, before (8a, 9a, 10a, 11a, and 12a) and after (8b, 9b, 10b, 11b, and 12b) exposure in FSU-1, as described in Comparative Example D;

FIGS. 13 and 14 are graphs showing normalized weight gain of samples described in Comparative Example D;

FIGS. 15a and 15b are photographs of the control coupon before (a) and after (b) exposure in FSU-1, as described in Comparative Example D;

FIGS. 16a and 16b are photographs of a coupon representing a surface according to an embodiment of the present invention described in Example 1; before (a) and after (b) exposure in FSU-1,

FIGS. 17a and 17b are photographs of a control carbon steel coupon described in Example 2; before (a) and after (b) exposure in FSU-2,

FIGS. 18a and 18b are photographs of a coupon representing a surface according to an embodiment of the present invention described in Example 2; before (a) and after (b) exposure in FSU-2;

FIG. 19 is a photograph of a coupon representing a surface according to an embodiment of the present invention described in Example 3; after exposure in FSU-2;

FIG. 20a is a photograph of a carbon steel control coupon following exposure, as described in Example 4;

FIGS. 20b and 20c are photographs of a smooth (b) and a roughened (c) coupon representing a surface according to embodiments of the present invention following exposure, as described in Example 4;

FIGS. 21a-d, 22a-c, 23a-c, 24a-b, and 25a-b are photographs showing a liner representing a surface according to embodiments of the present invention in FSU-2 following various exposures, as described in Example 5;

FIG. 26 is a photograph showing water droplets on the inside wall of a material discussed in Example 5; and

FIG. 27 is a photograph showing lined rods representing a surface according to an embodiment of the present invention following exposure in FSU-1 (left) and FSU-2 (right), as described in Example 6.

### DETAILED DESCRIPTION

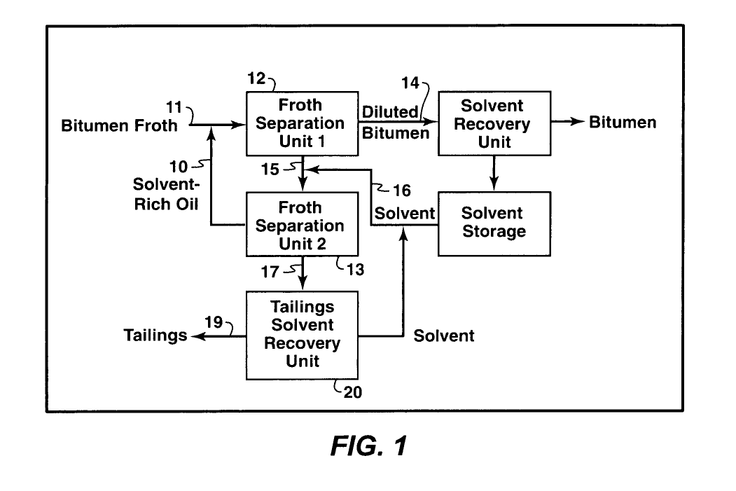

An example of a PFT process will now be described with reference to FIG. 1. Solvent 10 is mixed with the bitumen froth 11 counter-currently in the FSU, or as shown in FIG. 1, in two stages (FSU-1 (12) and FSU-2 (13)). In FSU-1 (12), the froth 11 is mixed with a solvent-rich oil stream 10 from FSU-2 (13). The temperature of FSU-1 is maintained at about 60 to 80° C., or about 70° C. and the target solvent to bitumen ratio is about 1.4:1 to 2.2:1 by weight or about 1.6:1 by weight. The overflow from FSU-1 is the diluted bitumen product 14 and the bottom stream 15 from FSU-1 is the tailings comprising water, solids (inorganics), asphaltenes, and some residual bitumen. The residual bitumen from this bottom stream 15 is further extracted in FSU-2 by contacting it with fresh solvent 16, for example in a 25:1 to 30:1 by weight solvent to bitumen ratio at, for instance, 80 to 100° C., or about 90° C. The solvent-rich overflow 10 from FSU-2 is mixed with the fresh froth feed 11 as mentioned above. The bottom stream 17 from FSU-2 is the tailings comprising solids, water, asphaltenes, and residual solvent. Residual solvent 18 is recovered prior to the disposal of the tailings 19 in the tailings ponds. Such recovery is effected, for instance, using a tailings solvent recovery unit 20 (TSRU), a series of TSRUs or by another recovery method. Typical examples of operating pressures of FSU-1 and FSU-2 are respectively 550 kPag and 600 kPag. FSUs are typically made of carbon steel but may be made of other materials. In such a process, significant fouling has been observed in FSU-2, and to a lesser extent in FSU-1. The foregoing is only an example of a PFT process.

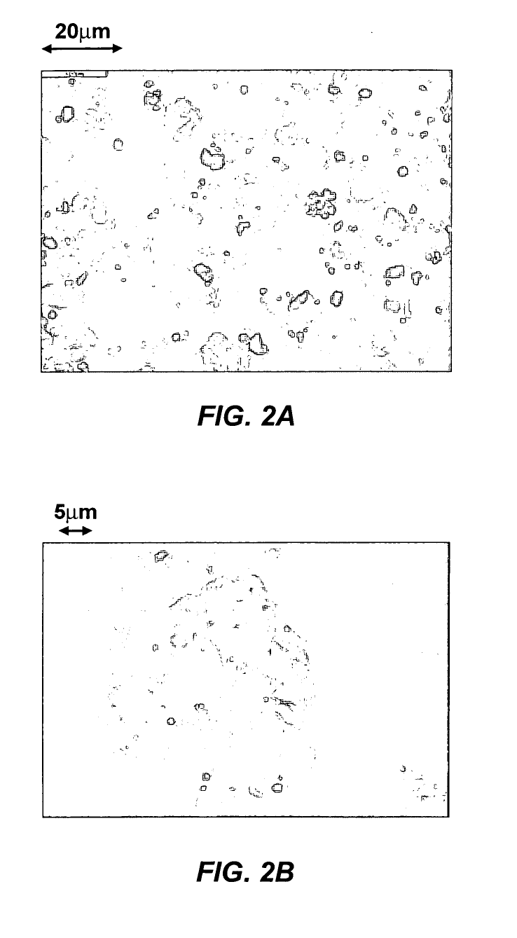

During pilot testing of a PFT process, the foulants of an FSU-1 and an FSU-2 (in a system as generally shown in FIG. 1) were analyzed. Foulant of FSU-1 comprised 46 percent volatiles (comprising water and pentane), 40 percent inorganics (comprising quartz, alumino silicates, carbonates, FeₓS_{y}, and titanium-rich minerals) and 14 percent NVHC (non-volatile hydrocarbons essentially comprising asphaltenes), all by weight. Foulant of FSU-2 comprised 50 percent volatiles (comprising water and pentane), 24 percent inorganics (comprising quartz, alumino silicates, carbonates, FeₓS_{y}, and titanium-rich minerals) and 26 percent NVHC (non-volatile hydrocarbons essentially comprising asphaltenes), all by weight. The foulant of FSU-2 had more asphaltenes than did the product bitumen. The H:C atomic ratio in the foulant was 1.2:1 to 1.3:1 compared to 1.35:1 in bitumen. Inorganics (quartz, alumino silicates, FeₓS_{y}, carbonates and TiO₂) identified in the foulant are similar to those typically present in the oil sands from which the bitumen has been extracted and made into a froth. The majority, by number, of the inorganic particulates is less than 1 μm in size. FIGS. 2a and 2b are scanning electron microscope (SEM) photographs showing evidence that the inorganics are held together by asphaltenes. In FIGS. 2a and 2b, the inorganics in the PFT foulant are light-colored and are glued together by the dark-colored asphaltenes.

It has been discovered that certain materials with sufficiently low surface energy and of sufficient purity are effective in reducing PFT fouling on the materials. That is, using such a material limits accumulation of foulant on the material. Such materials may therefore by used as an inner surface of a PFT vessel or conduit.

A solid material's surface energy is often assessed by measuring the water contact angle(s). Water contact angle is the angle at which a water interface meets the solid surface. Measuring water contact angles is described in “Polymer Interface and Adhesion,” S. Wu, Marcel Dekker, New York (1982), pages 257-260. As described below in the Examples section, water contact angles were measured herein using a VCA2500XE Video Contact Angle Analyzer from AST Products, Inc. (Billerica, Mass.).

The higher the contact angle, the lower the surface energy. On extremely hydrophilic surfaces, a water droplet will completely spread (an effective contact angle of 0 degrees). This occurs for surfaces that have a large affinity for water (including materials that absorb water). On certain hydrophilic surfaces, water droplets will exhibit contact angles of 10 degrees to 30 degrees. On highly hydrophobic surfaces, which are incompatible with water, one observes a large contact angle (70 degrees to 90 degrees). The contact angle thus provides information on the interaction energy between the surface and water. Thus, since a sufficiently low surface energy is desired herein, the water contact angle with the solid surface should be above a minimum value. In one embodiment, the material has an average water contact angle of at least 90 degrees; or at least 100 degrees, or at least 110 degrees, or at least 115 degrees, or about 116 degrees to about 123 degrees. The theoretical maximum water contact angle with a surface is 180 degrees. In one embodiment, the average water contact angle is no more than 170 degrees and at least 90 degrees, or at least 100 degrees, or at least 110 degrees, or at least 115 degrees.

Uniformity of surface energy also assists a reduction in fouling. To quantify uniformity, standard deviation is used herein. In particular, for the purposes of quantitative comparison, standard deviation of a surface's water contact angles is divided by the surface's average water contact angle. In this way, relative deviation is assessed. A Teflon® coated coupon (as used in Comparative Example D) was tested and showed water contact angles of 55 degrees, 100 degrees, and 120 degrees, which calculates to an average of 91.7 degrees, a standard deviation of 33.9 degrees, and a standard deviation of water contact angles divided by the average water contact angle of about 0.36. The surface is relatively non-uniform. On the other hand, a coupon according to an embodiment (as shown in Example 1) was shown to have the following water contact angles: 116.9 degrees, 115 degrees, 112 degrees, 112 degrees, 117.9 degrees, 116.5 degrees, 117 degrees, 116.5 degrees, and 116.5 degrees, which calculates to an average of 115.2 degrees, a standard deviation of 1.92 degrees, and a standard deviation of water contact angles divided by the average water contact angle of 0.017. Likewise, a liner according to an embodiment (as shown in Example 5) was shown to have the following water contact angles: 116.8 degrees, 117.9 degrees, 121.9 degrees, 116.1 degrees, 121.0 degrees, and 123.0 degrees, which calculates to an average of 119 degrees, a standard deviation of 3.03 degrees, and a standard deviation of water contact angles divided by the average water contact angle of 0.03 (i.e. relatively uniform). In one embodiment, the water contact angles of a surface has a standard deviation divided by the average water contact angle of less than 0.1, or less than 0.05, or less than 0.03, or less than 0.02, lower values indicating more uniform surfaces in terms of surface energy. In one embodiment, the standard deviation is less than 20, less than 10, less than 5, less than 3, or less than 2.

Purity of the material is desirable because a non-uniform composition may provide for nucleation sites causing foulant to grow and build. Impurities are defined herein as anything other than the monomer(s) of the homopolymer or copolymers used. Copolymer is not limited to only two monomers. In one embodiment, the material has an impurity content of less than: 1000 ppmw, or 100 ppmw, or 10 ppmw, or 1 ppmw, or 100 ppbw, or 10 ppbw.

The material may be a fluorocarbon polymer. The material may be a fluoroplastic, for instance PTFE (polytetrafluoroethylene)-based polymers, meaning homopolymers of TFE (tetrafluoroethylene) or copolymers of TFE with one or more monomers comprising at least one ethylene type unsaturation. In certain embodiments, the comonomer content is less than 2 percent or less than 1 percent, by weight. The comonomers having ethylene unsaturation which can be used are both of hydrogenated and fluorinated type; among the hydrogenated ones it can be mentioned: ethylene, propylene, acrylic monomers, for example methylmethacrylate, (meth)acrylic acid, butylacrylate, hydroxyethylhexylacrylate, styrene monomers, such as, for example, styrene. Among the fluorinated comonomers it can be mentioned:

C₃-C₈ perfluoroolefins, such as hexafluoropropene (HFP);

C₂-C₈ hydrogenated fluoroolefins, such as vinyl fluoride (VF), vinylidene fluoride (VDF), trifluoroethylene, hexafluoroisobutene, perfluoroalkylethylene CH₂═CH—R_{f}, wherein R_{f} is a C₁-C₆ perfluoroalkyl;

C₂-C₈ chloro- and/or bromo- and/or iodo-fluoroolefins, such as chlorotrifluoroethylene (CTFE);

CF₂═CFOR_{f} (per) fluoroalkylvinylethers (PAVE), wherein R_{f} is a C₁-C₆ (per)fluoroalkyl, for example CF₃, C₂F₅, C₃F₇; and

CF₂═CFOX (per) fluoro-oxyalkylvinylethers, wherein X is: a C₁-C₁₂ alkyl, or a C₁-C₁₂ oxyalkyl, or a C₁-C₁₂ (per) fluoro-oxyalkyl having one or more ether groups, for example perfluoro-2-propoxy-propyl, fluorodioxoles, preferably perfluorodioxoles.

Examples of embodied comonomers include a C₃-C₈ perfluoroolefin, a C₂-Cₐ chloro-, bromo- and/or iodo-fluoroolefin, a (per)fluoroalkylvinylether of formula CF₂═CFOR_{f}(PAVE), wherein R_{f} is a C₁-C₆ (per)fluoroalkyl, a (per)fluoro-oxyalkyvinylether of formula CF₂═CFOX, wherein X is a C₁-C₂ alkyl, a C₁-C₁₂ oxyalkyl, and a C₁-C₁₂ (per)fluoro-oxyalkyl having one or more ether groups.

Other suitable polymers include: PFA (perfluoroalkoxy), FEP (fluorinated ethylene prolylene), ETFE (ethylene tetrafluoroethylene), ECTFE (ethylene chlorotrifluoroethylene), PVDF (polyvinylidene fluoride), or PCTFE (polychlorotrifluoroethylene).

The material may also be a fluorocarbonelastomer or a tetrafluorocarbonelastomer. An example of a fluorocarbonelastomer is a copolymer of vinylidene fluoride and hexafluoropropylene, an example of which is commercially known as Viton™.

As shown in the examples below, a surface that was roughened to a surface roughness of 0.32 μm was nonetheless found effecting in reducing fouling. In certain embodiments the surface roughness is less than 0.5 μm, less than 0.45 μm, or no more than 0.32 μm.

Polymers sold under the Teflon® name currently comprise PTFE, PFA (perfluoroalkoxy), or FEP (fluorinated ethylene prolylene). A Teflon® spray coated surface is proven ineffective below. In order to apply such a Teflon® coating, certain additives (or fillers) are used to permit or assist spraying and adhesion. Without being bound by theory, such additives are believed to be a factor in this ineffectiveness. Therefore, a Teflon®-type material may be useful provided that the additives are sufficiently reduced to obtain a sufficiently high purity and provided that the surface energy is low enough. To accomplish this, spraying may be avoided. For instance, a piece of material may be manufactured, for instance by molding, out of PTFE and affixed to, or suspended within, a vessel or conduit used in the PFT process.

Because of the purity and maximum surface energy requirements, alternative ways of creating a surface may be used, although spraying could be used if the purity and surface energy requirements are met. Such alternative ways of applying a surface may depend on, for instance, the vessel or conduit, and the particular material selected. In one embodiment, pieces of material of convenient size are fabricated and a plurality of such pieces are inserted into slots to cover at least a portion of the walls of a vessel. Such pieces could alternatively be adhered or affixed to the inside of the vessel or conduit. The surface may be applied to any portion of the vessel or conduit and need not cover it entirely. For instance, the surface may be applied to areas where foulant would otherwise significantly or preferentially accumulate. Alternatively, the conduit or vessel itself could be made of the material. Painting could also be used to create the surface.

As shown in the examples below, a liner molded from a resin having specification according to ASTM D 4894-98a of Type IV, Grade 2 was found to be effective. In one embodiment, the material is a material in accordance with ASTM D 4894-98a, Type I, II, III, or IV (any of the grades). This standard covers granular resins for polytetrafluoroethylene (PTFE) that have never been preformed or molded and are normally processed by methods similar to those used in powder metallurgy or ceramics or special extrusion processes. The PTFE resins of this ASTM standard are homopolymers of tetrafluoroethylene, or, in some cases, modified homopolymers containing no more than one percent by weight of other fluoropolymers. The materials of this ASTM standard do not include mixtures of PTFE resin with additives such as colorants, fillers or plasticizers; nor do they include processed or reground resin. The resin of this ASTM standard is said to be uniform and contain no additives or foreign material.

In one embodiment, the fluorocarbon polymer may be made by molding, isostatic molding, and/or using a material as specified by ASTM D 4894-98a or ASTM D 4895-04.

### EXAMPLES

The water contact angle measurements described in these examples were obtained using a VCA2500XE Video Contact Angle Analyzer from AST Products Inc. (Billerica, Mass.).

The carbon steel (CS) mentioned in these examples is 1080 steel.

Comparative examples A to D show that conventional anti-fouling materials, including five state-of-the-art materials recommended by experts in fouling related subject matter were unsuccessful in reducing fouling of the FSU vessels in the PFT. Examples 1 to 6 show the efficacy of a material according to embodiments of the present invention in reducing fouling, both as coupons and as a liner. The tests in all these examples were carried out in a 30 bbl/day continuous PFT pilot.

The pilot ran continuously for 72 hours followed by a weekend shutdown, and then for another 72-hour continuous run, followed by a one-week maintenance shutdown. The coupons were suspended from the top of the settler pipe section of FSU-1 and FSU-2 using stainless steel hooks and examined after each 72-hour continuous run.

### Comparative Example A

### Conventional Cement and Ceramic Anti-Fouling Materials in FSU-1

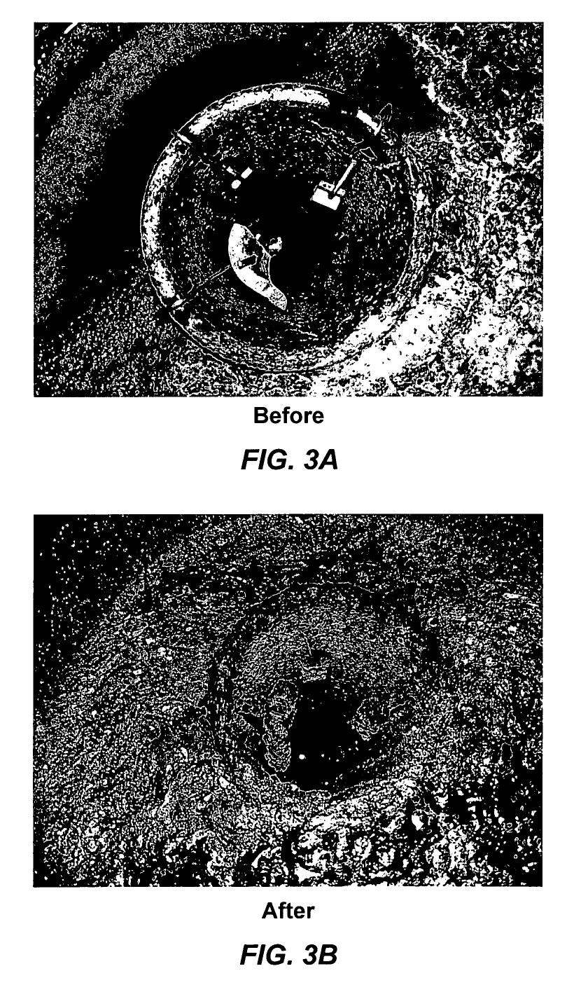

In FSU-1, a cement coupon (cement from Cement Lining Corporation, International, Houston, Tex.), and a carbon steel coupon coated with Kalceram™ (a ceramic from Abresist Corporation, Urbana, Ind.) were evaluated. A carbon steel coupon was also included as a control. The three coupons were suspended by steel wires from the top of the settler pipe section in FSU-1 (FIG. 3a). After being exposed to foulant over a period of 72-hours continuously, all three coupons were covered with foulant (FIG. 3b).

Example A shows that neither the cement nor the ceramic (Kalceram™) significantly reduced fouling in FSU-1.

### Comparative Example B

### Conventional Cement and Ceramic Anti-Fouling Materials in FSU-2

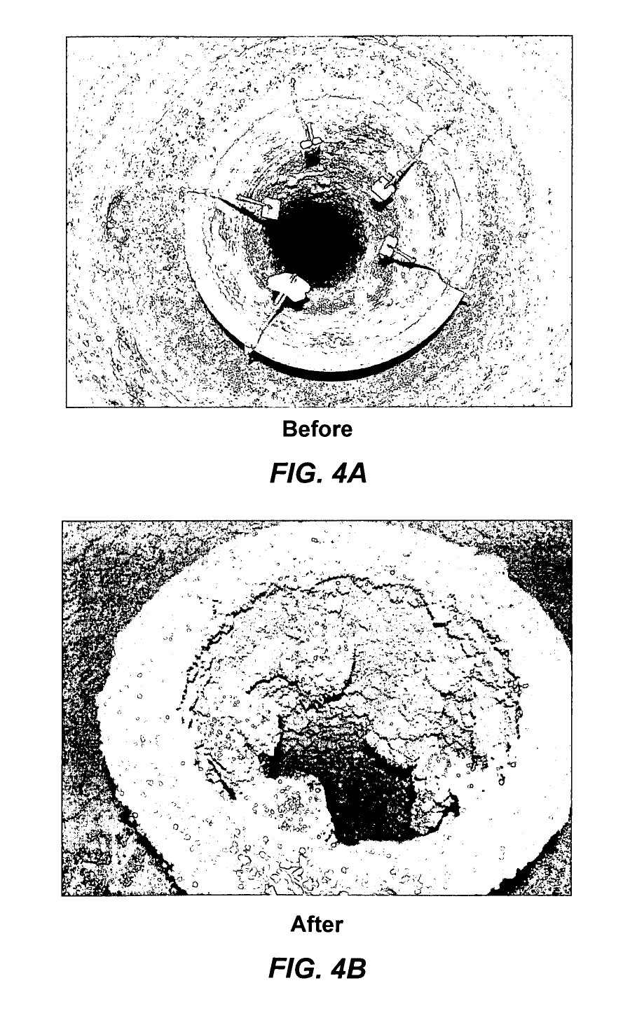

Four conventional anti-fouling materials: three ceramics (Abresist™, Alresist™ and Kalceram™, all from Abresist Corporation, Urbana, Ind.) and a cement were evaluated in FSU-2. The coupons from these materials along with a control carbon steel coupon are shown in FIG. 4a before the run. After the 72-hour run, all the coupons including the control one suffered a significant amount of fouling (FIG. 4b).

This example shows that none of the four conventional anti-fouling materials tested significantly reduced fouling in FSU-2.

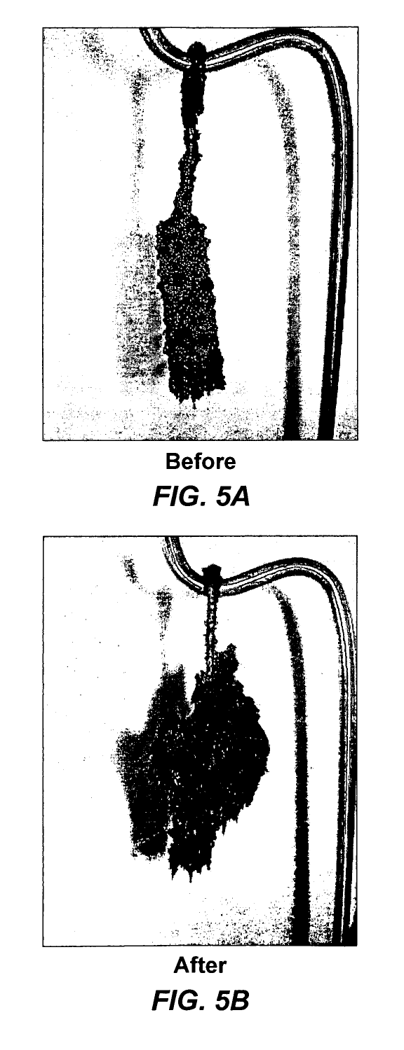

The higher amount of foulant build up in all the FSU-2 coupons compared to FSU-1 coupons is evident when FIGS. 4a and 4b in Comparative Example B are compared with FIGS. 3a and 3b in Comparative Example A. This is also evident when the control carbon steel coupon from FSU-2 is compared with that from FSU-1 (FIG. 5a (FSU-1) and FIG. 5b (FSU-2)).

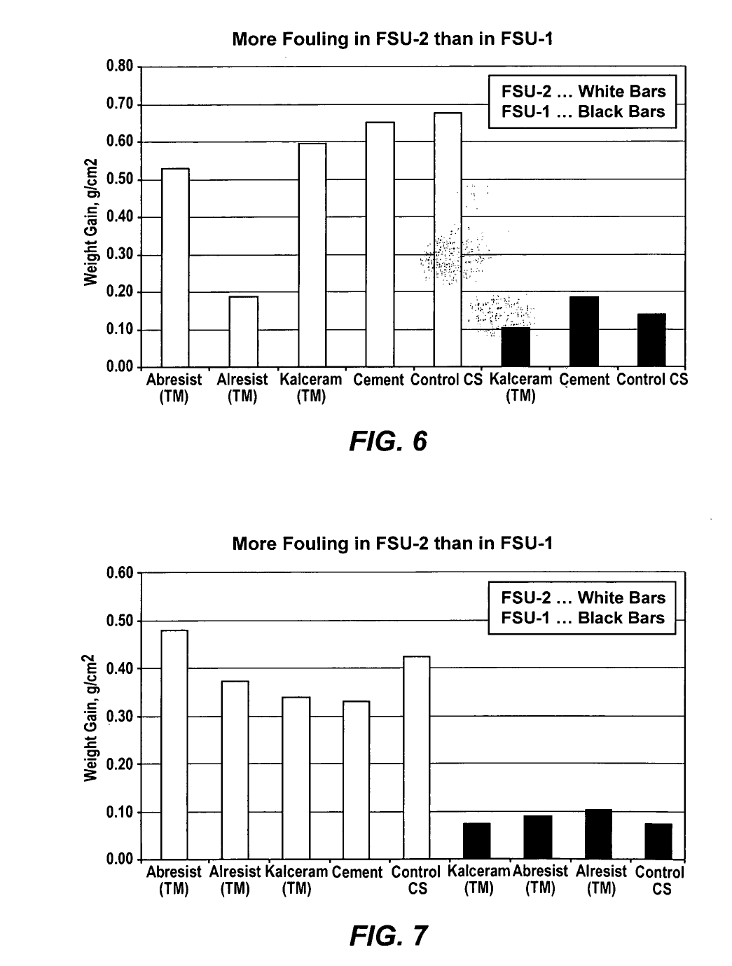

For the coupons listed in Comparative Examples A and B, the weight gain by each coupon was measured, normalized by the total surface area and reported as weight gain per cm². FIG. 6 shows the weight gain by the coupons in FSU-1 and FSU-2 after a 72-hour run. The higher foulant build-up in FSU-2 is again apparent on each of the coupons.

It should be noted that although some of the coupons in FIG. 6 gained a little bit less weight than the control carbon steel coupon, the build-up was still too severe to make them useful as an anti-fouling coating for the PFT vessels. The Alresist™ coupon appeared to have gained the least weight in these tests. However, this was due to the fact that the foulant was loosely bonded to the coupon surface and some of it probably fell off prior to weighing.

### Example C

### Repeat Evaluation of Cement and Ceramic Materials in FSU-1 and FSU-2

This example shows the results from the repeat of the tests in Examples A and B. The coupon materials and the exposure time of 72 hours in the repeat tests were the same as those in Examples A and B. The weight gains by the coupons in the repeat tests are shown in FIG. 7.

The reproducibility in the weight gain by the coupons (by comparing FIG. 7 with FIG. 6) was reasonable in view of the fact that some foulant might have fallen off because of the friable nature of the foulant. As in Comparative Examples A and B, none of the conventional coupons evaluated in the repeat tests reduced fouling, although some gained less weight than the control carbon steel (CS) coupons. Unlike the test in Comparative Example B, the Alresist™ coupon in the repeat test showed weight gain which was in line with those by the other coupons, confirming the hypothesis that its relatively lower weight gain in Comparative Example B was due to some of the foulant falling off prior to weighing. Consistent with Comparative Examples A and B, the repeat tests also show higher fouling in FSU-2 than in FSU-1.

### Comparative Example D

### State-of-the-Art Antifouling Materials

Five anti-fouling materials recommended by fouling experts were also evaluated in FSU-1 and FSU-2. These materials were considered to be leading edge in combating fouling in downstream applications in the petroleum industry. These were:

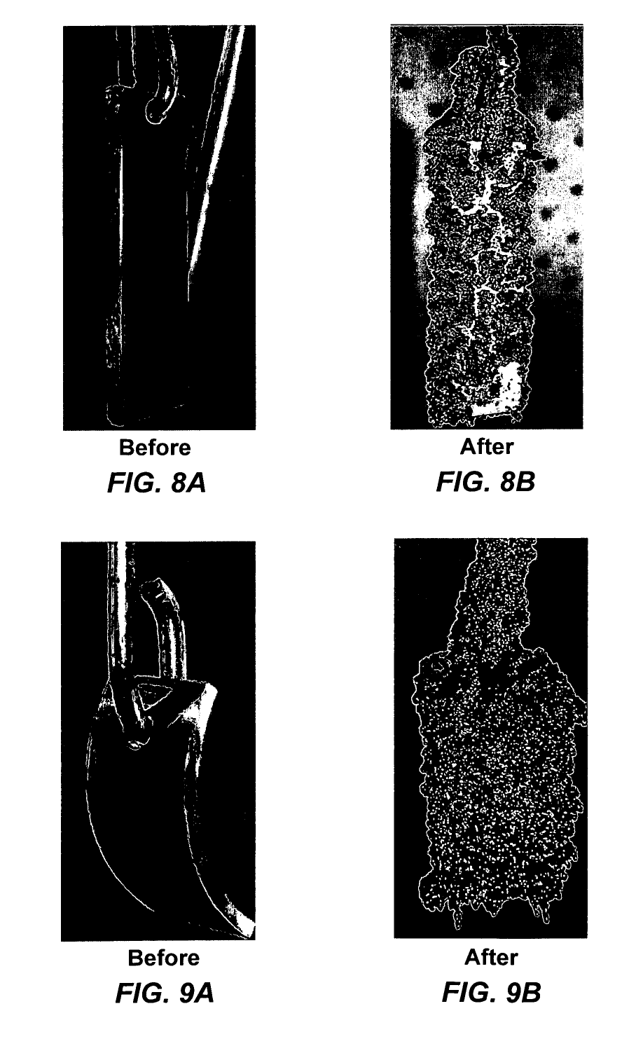

1. Teflon®-coated carbon steel (FIG. 8) in FSU-1;

2. DLC (Diamond-Like Carbon, from Sub-One Technology, Pleasonton, Calif.) (FIG. 9) in FSU-1;

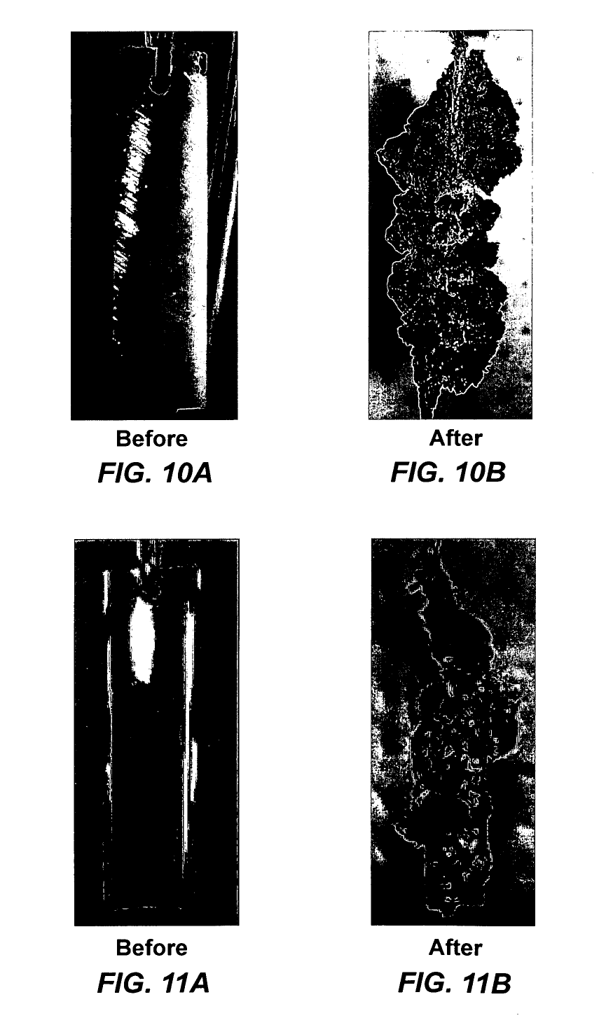

3. FRP (Fibre Reinforced Plastic; FIG. 10) in FSU-2;

4. Electro-polished steel (FIG. 11) in FSU-1; and

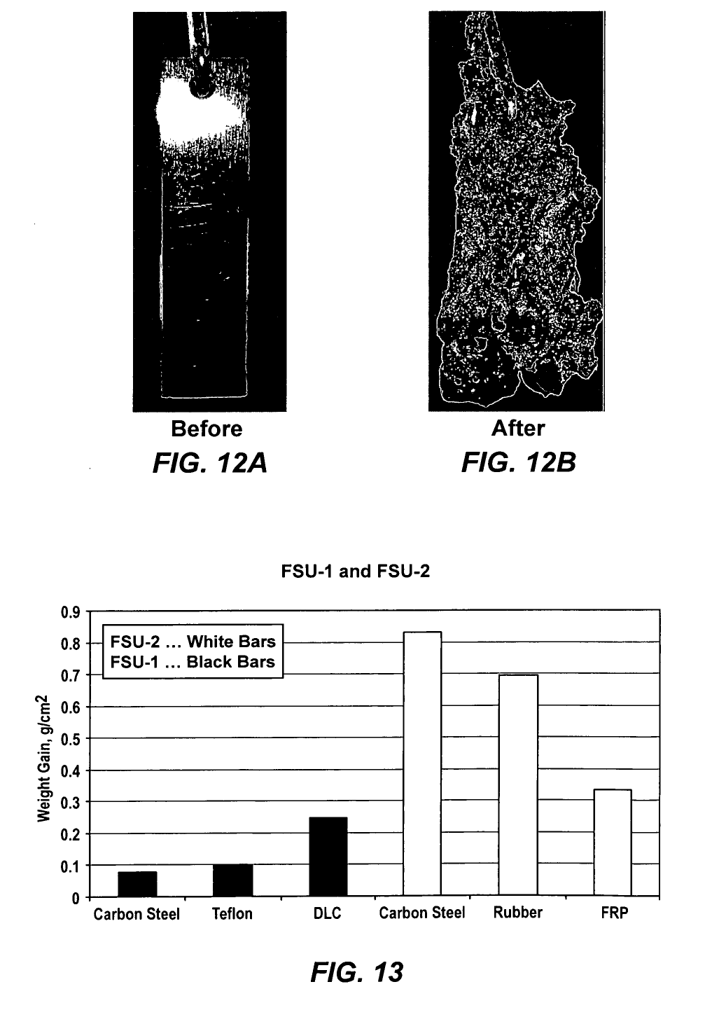

5. Ni—P Plated 5-Cr (FIG. 12) in FSU-1.

Four of the five coupons were exposed to the lesser fouling environment in FSU-1 and only the FRP coupon was placed in FSU-2. The exposure time in each case was 72 hours.

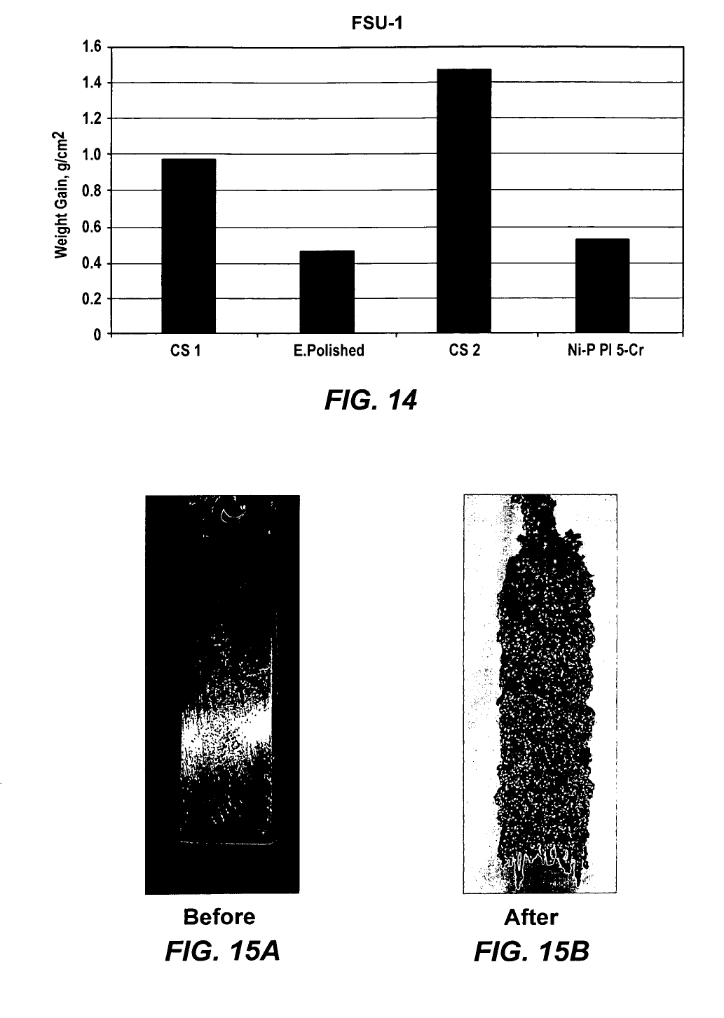

FIGS. 8 to 12 are the “Before” and “After” photographs of the Teflon®-coated carbon steel, DLC, FRP, electropolished steel and Ni—P plated 5-Cr coupons, respectively. FIGS. 13 and 14 show the normalized weight gains (g/cm²) by these coupons, along with carbon steel control coupons used in the same tests for comparison.

The following observations were made from the testing of these coupons:

(a) all of these coupons, including the Teflon®-coated carbon steel, collected foulant;

(b) the Teflon®-coated carbon steel coupon had some isolated streaks that were not fouled (FIG. 8). It gained slightly more weight than the control carbon steel coupon (FIG. 13);

(c) the FRP coupon also had streaks of un-fouled areas (FIG. 10) and its weight gain was lower than that by the carbon steel coupon (FIG. 13); and

(d) the electro-polished steel and Ni—P Plated 5-Cr (shown in FIG. 14 as E. Polished and Ni—P PI 5-Cr, respectively) gained less weight than the carbon steel coupons (FIG. 14), but the fouling was too severe to be suitable for commercial application.

This example shows that all of the five state-of-the-art coupons failed to significantly reduce fouling in the FSUs, four of them (Teflon®-coated CS, DLC, electropolished steel and Ni—P plated 5-Cr) in FSU-1 where fouling is normally less than that in FSU-2 by a factor of about 3 to 4. The coupons performed better than the control carbon steel coupons (CS 1 and CS 2 in FIG. 14), but the fouling was too severe to warrant their commercial use. CS 1 and CS 2 are different samples of the same carbon 1080 steel material.

### Example 1

### Anti-Fouling Material According to an Embodiment of the Present Invention, in FSU-1

A LEAP coupon (wherein “LEAP” stands for Low Energy And Of Pure Composition) made of PTFE (polytetrafluoroethylene) and falling under the designation “PTFE636-N” was supplied by Endress+Hauser Canada of Burlington, ON, Canada. The coupon had an internal diameter of 1.5 cm and a length of 5.1 cm and was cut from a tube fabricated by extrusion of a pure-grade material with a surface roughness of less than 0.45 μm. Water contact angle measurements were taken at nine different locations on the surface. The following angles were observed (in degrees): 116.9, 115.0, 112.0, 112.0, 117.9, 116.5, 117.0, 116.5, and 116.5 calculating to an average of 115.2 degrees. The standard deviation is 1.92 degrees. The standard deviation divided by the average is 0.02. For evaluating anti-fouling properties, the LEAP coupon was placed in the same area and in the same manner as the coupons in Comparative Examples A to D. The LEAP coupon was exposed to FSU-1 slurry along with a carbon steel control coupon for a period of 72 hours.

FIGS. 15a and 15b show the control coupon before and after exposure. The fouling after 72 hours of exposure is quite substantial.

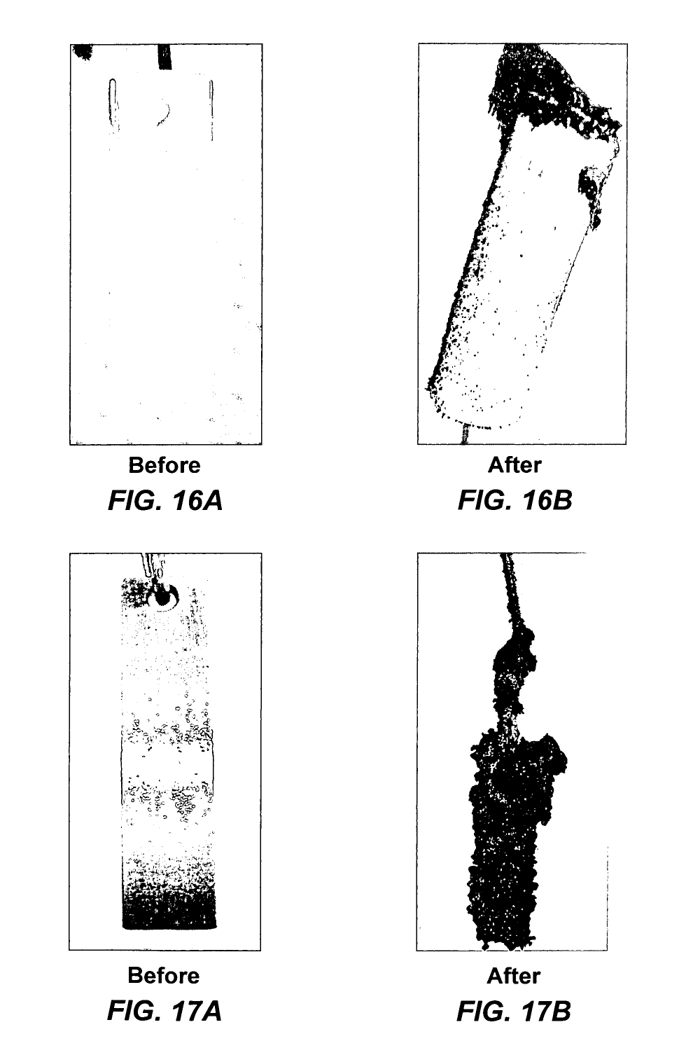

FIGS. 16a and 16b are photographs of the LEAP coupon before (FIG. 16a) and after (FIG. 16b) exposure in FSU-1. The LEAP coupon compared to the control carbon steel coupon was remarkably clean after the same amount of exposure. The foulant seen near the top and on the left side of the coupon deposited initially on the stainless steel hook used to hang the coupon inside FSU-1. The foulant later draped over to side of the coupon.

This example shows the efficacy of the LEAP material of Example 1 in reducing foulant build-up in FSU-1. Its performance is significantly better than each of the five state-of-the-art anti-fouling materials of Comparative Example D and the three other conventional anti-fouling materials (Comparative Examples A to C) evaluated in FSU-1 at essentially similar operating conditions. While some of the other materials reduced the amount of fouling relative to carbon steel, the LEAP material of Example 1 significantly reduced fouling.

### Example 2

### Anti-Fouling Material According to an Embodiment of the Present Invention, in FSU-2

A new LEAP coupon with the same dimensions and surface properties as the one in Example 1 was placed in FSU-2, close to the wall near the top of the pipe section of the settler. A carbon steel control coupon was also placed next to the LEAP coupon of Example 2 for comparison.

FIG. 17 shows the control coupon before and after exposure. The fouling after 72 hours of exposure is quite substantial.

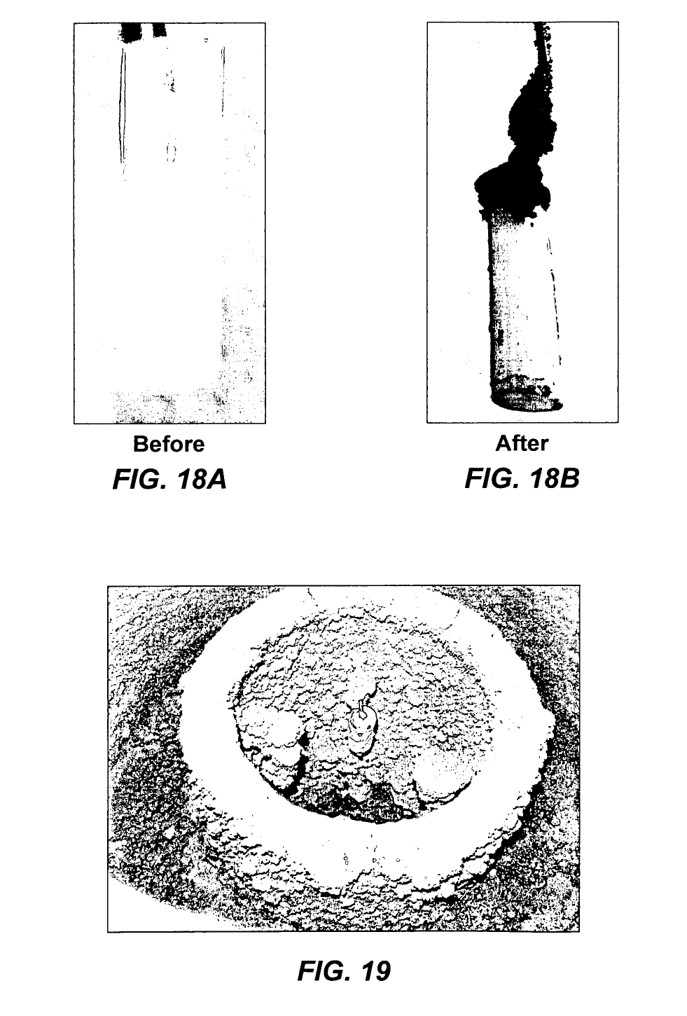

As shown in FIGS. 18a and 18b, little foulant collected on the coupon. As in Example 1, the foulant seen near the top of the LEAP coupon deposited initially on the stainless steel hook (used to hang the coupon inside the vessel) and then draped over to the side of the coupon. By comparison, a significant amount of foulant deposited on the control carbon steel coupon (FIG. 17) that was placed next to the LEAP coupon of Example 2 in the same test.

This example shows the efficacy of the LEAP material of Example 2 in reducing foulant build-up in FSU-2. Its performance is significantly better than each of the five state-of-the-art anti-fouling materials of Comparative Example D, four of which were tested in a less severe fouling environment of FSU-1 and six other conventional anti-fouling materials evaluated in FSU-2 (Comparative Examples A to C) at essentially similar operating conditions. While some of the other materials reduced the amount of fouling relative to carbon steel coupon, the LEAP material of Example 2 significantly reduced fouling.

### Example 3

### Anti-Fouling Material According to an Embodiment of the Present Invention, in FSU-2 for 144 Hours

The LEAP coupon from Example 2 after 72 hours of exposure in FSU-2 was placed again in FSU-2 for another 72 hours exposure without any cleaning between the two exposures. Three other coupons were also placed in the vessel: a new control carbon steel coupon, a new conventional anti-fouling coupon (Siloxirane® Polymer from Advanced Polymer Coatings, Carlstadt, N.J.), and a control carbon steel coupon previously exposed for 72 hours (and not cleaned) in FSU-2.

The LEAP coupon of Example 3 (white coupon in the centre of FIG. 19) did not collect any foulant, while both the new carbon steel coupon (left of the LEAP coupon of Example 3 in FIG. 19) and the Siloxirane® anti-fouling coupon (right of the LEAP coupon in FIG. 19) were covered with a significant amount of foulant. The previously exposed carbon steel coupon, which is opposite the LEAP coupon of Example 3 and is not visible in FIG. 19, also collected foulant.

This example demonstrates the ability of the LEAP material of Example 3 in reduced fouling under conditions when large build-up occurs in a carbon steel coupon and another conventional anti-fouling material.

### Example 4

### Effect of Surface Roughness on LEAP's Anti-Fouling Effectiveness

In this example, a LEAP coupon was intentionally made rougher to simulate a level of roughness that may result with prolonged exposure to the slurry in FSU-1 and FSU-2. This rougher coupon was prepared by grinding a LEAP coupon (with an initial surface roughness matching those in Examples 1 to 3) with a 180 grit sand paper in a lathe in a single pass, resulting in a surface roughness of 32 g. It is unlikely that this kind of surface roughness would be seen in an FSU, where the slurry is not very erosive, as the majority of the inorganics particles in the foulant is usually less than 1 μm.

For the test, the rougher PTFE coupon was placed inside FSU-2 along with a smooth LEAP coupon (the smooth coupon being similar to the LEAP coupon used in Examples 1-3) and a control carbon steel coupon for a 72-hour exposure.

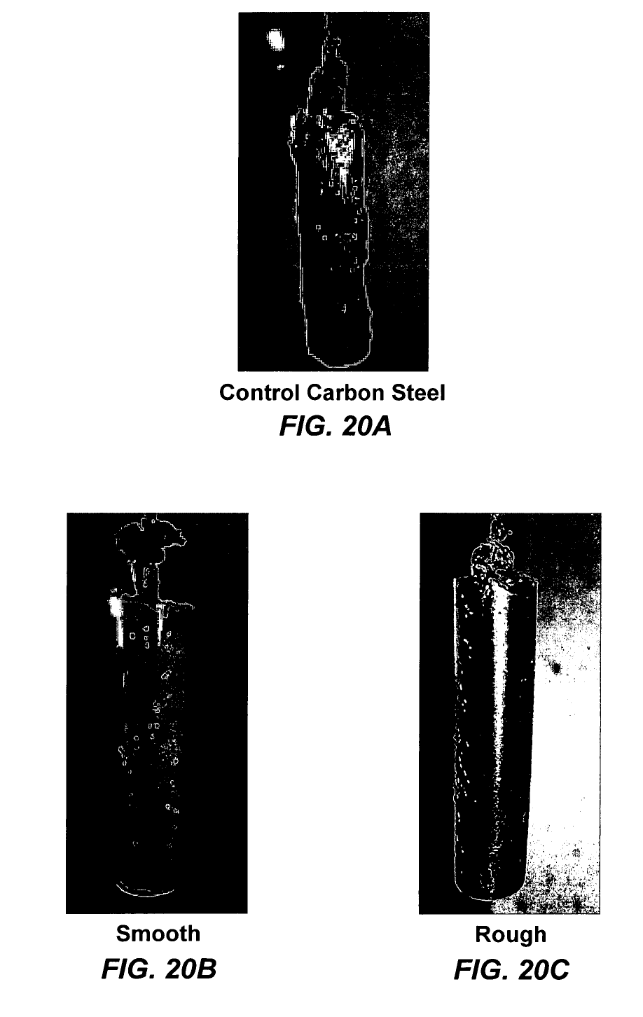

As shown in FIGS. 20a to 20c, the control carbon steel coupon was significantly fouled, while the smooth LEAP coupon was clean, retaining its original translucent white color. The rougher LEAP coupon did not collect any deposit, was stained to a light-brown in color by the light hydrocarbon from the slurry.

This example shows that increasing the surface roughness of LEAP to roughness level beyond what would be expected to result in a PFT process environment, does not interfere with its ability to reduce foulant build-up. This point is confirmed by the long-term (>six months) evaluation of the LEAP material in Example 6.

### Example 5

### LEAP Liner in FSU-2

Examples 1 to 4 demonstrated the effectiveness of the LEAP coupons in reducing fouling in both FSU-1 and FSU-2. These examples and Comparative Examples A to D clearly show that the LEAP was the only material out of those tested that is capable of significantly reducing fouling. However, the LEAP coupons in those tests were relatively small (1.5 cm ID and 5.1 cm long) compared to the diameter of FSU-2 and were not tested for a period longer than 144 hours. In Example 5, a LEAP material was used as a liner whose outer diameter was close to the internal diameter of the settler pipe section of FSU-2. In addition, the liner was also tested for five consecutive 72-hour runs for a total exposure of 360 hours.

The LEAP liner was procured from a different vendor (Eldon Group, Avondale, Pa.), who fabricated it by isostatic molding. This liner satisfies ASTM D 4894-98a Type IV, Grade 2. The liner had no filler or extrusion aid. This ASTM standard stipulates among other things that: (1) the PTFE resins are homopolymers of tetrafluoroethylene, or, in some cases, modified homopolymers containing no more than one percent by weight of other fluoropolymers; and (2) the materials do not include mixtures of PTFE resins with additives such as colorants, fillers or plasticizes. Water contact angles were measured as follows at different locations: 116.8 degrees, 117.9 degrees, 121.9 degrees, 116.1 degrees, 121.0 degrees, and 123 degrees which calculates to an average of 119 degrees. The standard deviation is 3.03 degrees. The standard deviation divided by the average is 0.025.

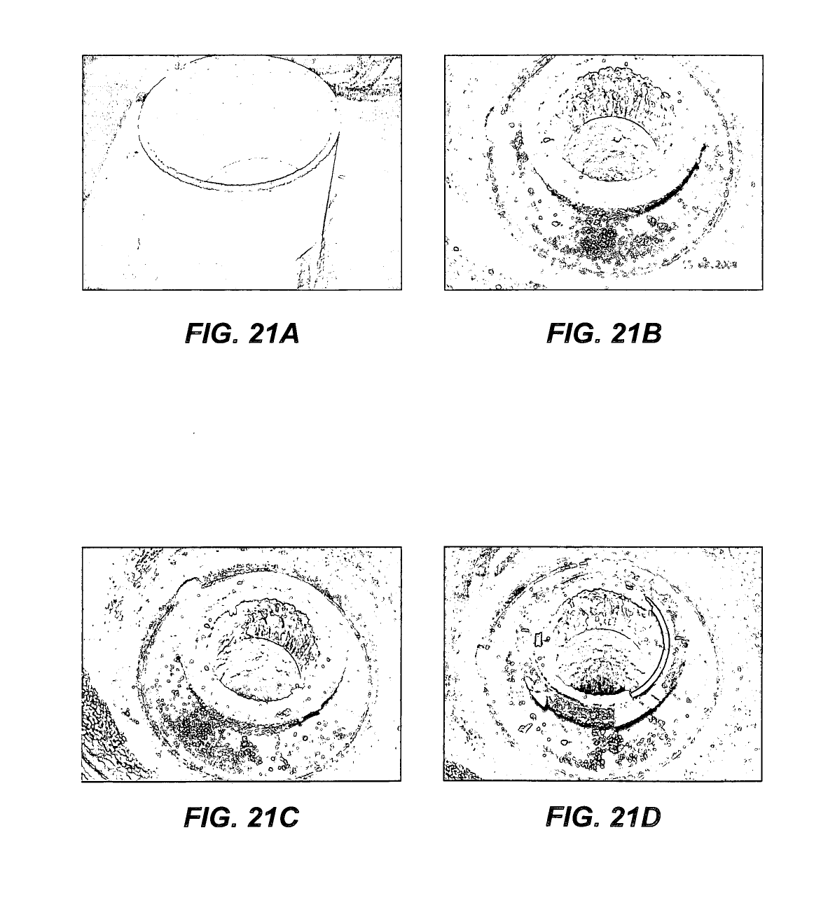

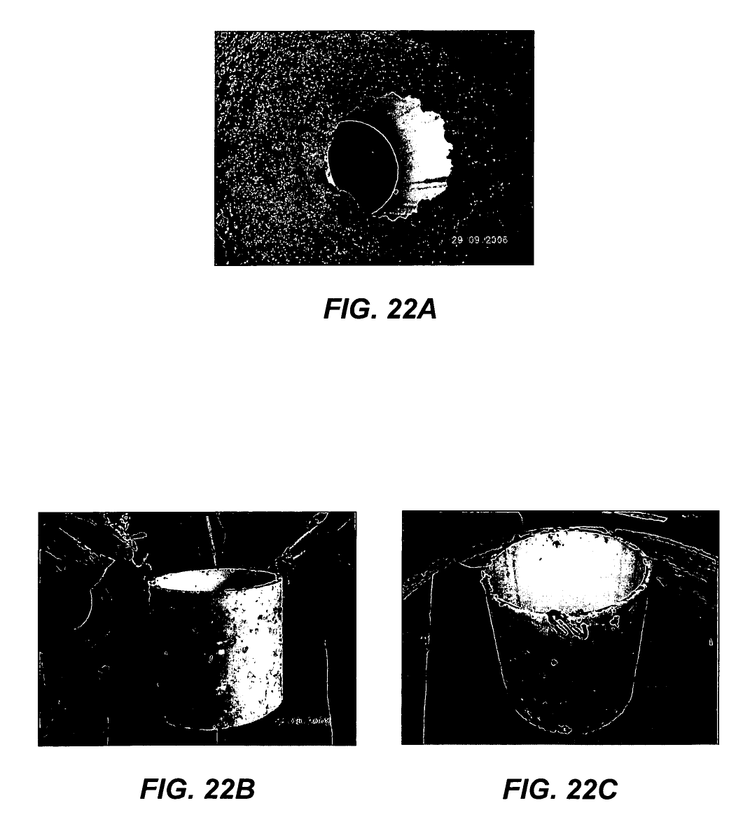

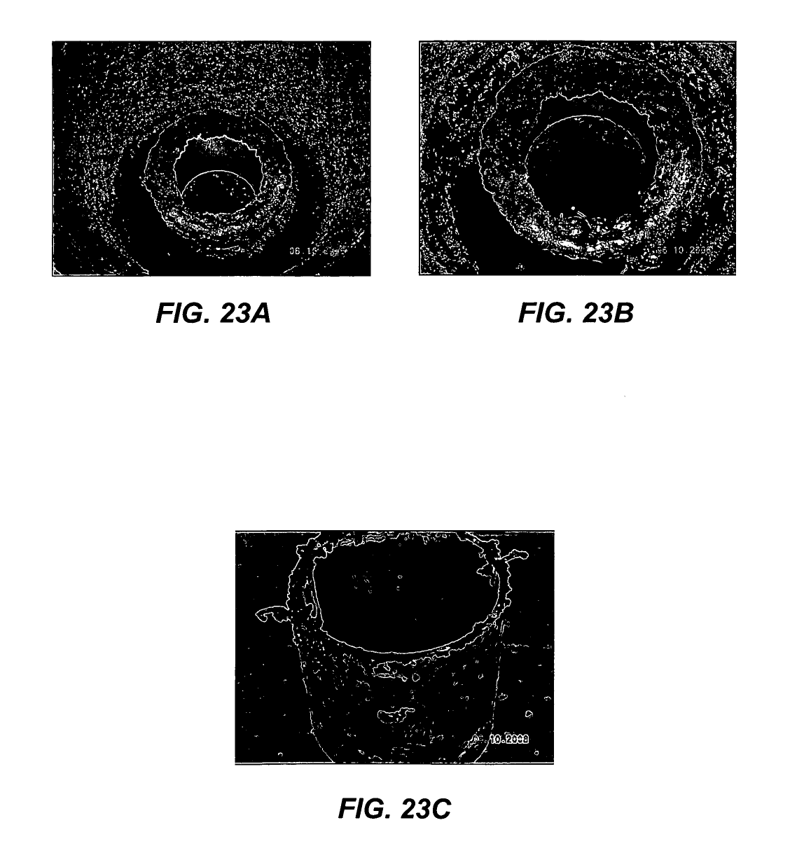

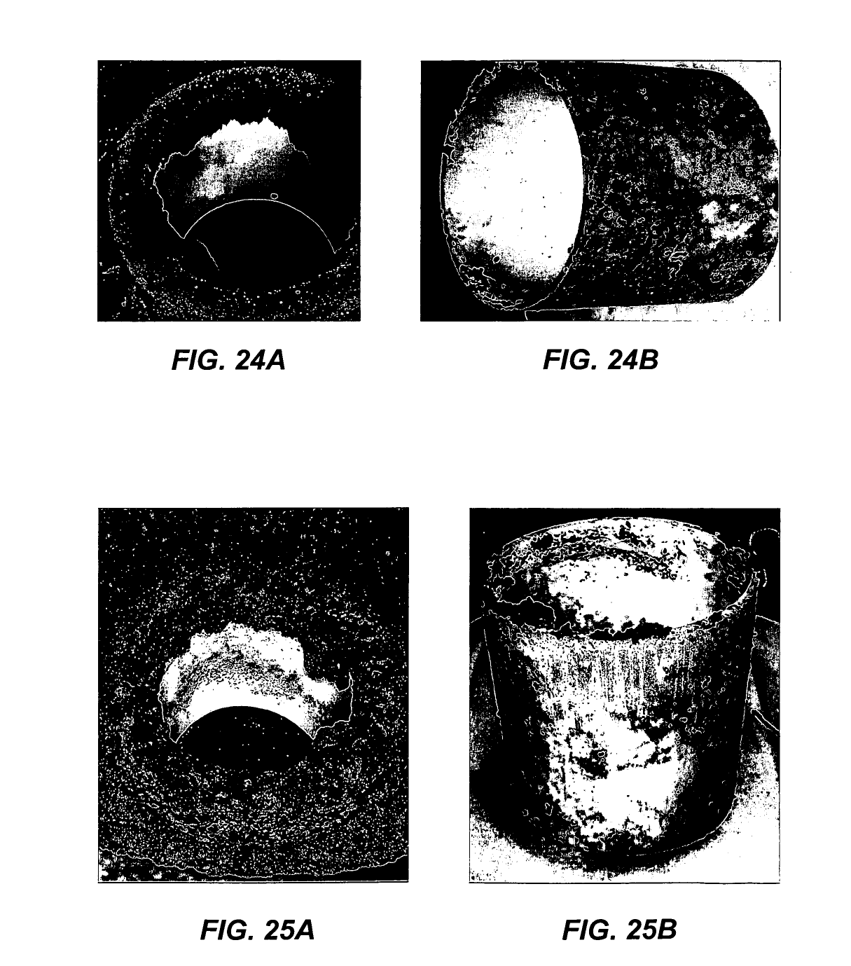

The LEAP coupons in Examples 2, 3 and 4, by contrast, were cut from a tube that was fabricated by extrusion. The fabrication by molding resulted in the outer wall of the liner being rougher than the inner wall contacting the slurry with the foulant. The cylindrical liner (FIG. 21a) was cut from a 61 cm long pipe and had the following dimensions: L: 13.34 to 14.0 cm (the variation due to a non-uniform cut); OD: 13.36 cm; and ID: 12.64 cm.

Two stainless steel hooks were used to hang the liner from the top of the weir in FSU-2. The clearance between the liner and settler pipe was less than 5 mm. The experimental protocol called for exposing the liner to FSU-2 slurry for a normal 72-hour run, and determining the extent of fouling by photographing and inspecting it visually. It was then exposed for four more 72-hour runs without any cleaning in-between the runs, for a total of 360 hours of exposure. FSU-2 was chosen for the liner evaluation over FSU-1 because of its higher fouling propensity.

The results from the five 72-hour runs with the liner are shown in FIGS. 21 to 25. In each figure, there is noticeable foulant build-up below and above the liner, while the liner is essentially clean apart from some light oil stains. FIG. 21a is before exposure.

In addition to showing no build-up on the inner wall of the liner, FIGS. 21b to 25 show that there was no build-up in the outer wall, which is the rougher of the two walls. This is consistent with the result from Example 4 in which the LEAP coupon with the rougher surface also significantly reducing fouling, indicating the robustness of the LEAP material in combating fouling.

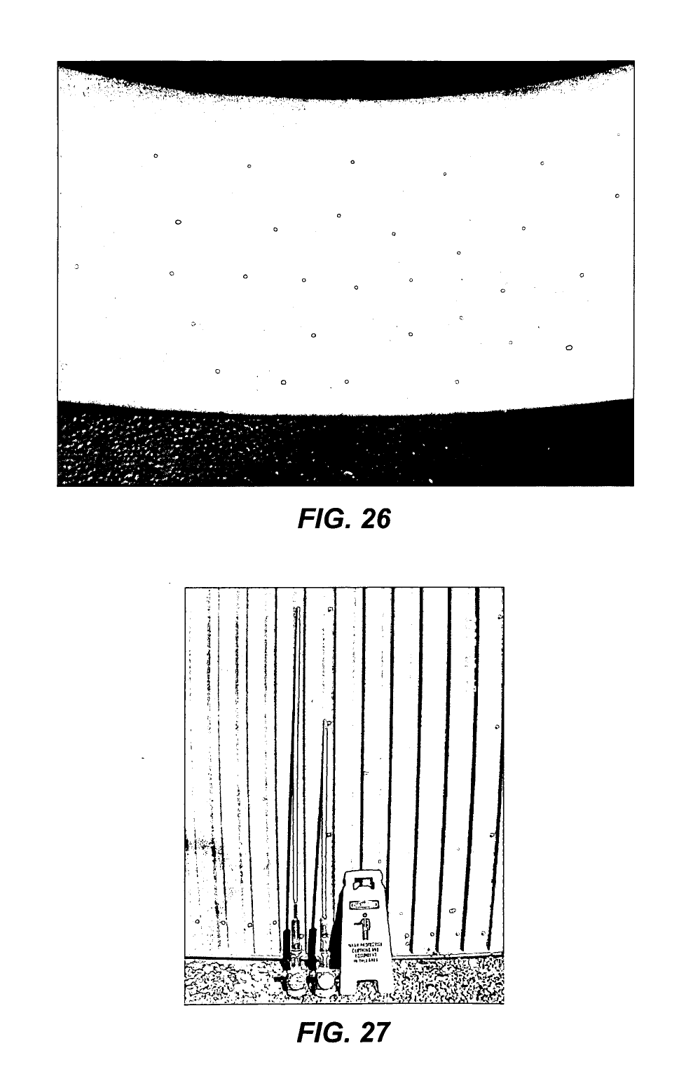

FIG. 26 is a photograph showing water droplets on the inside wall of the LEAP liner. Calgary municipal water droplets were placed on the inside wall of the 13.36 cm liner using a syringe. All water droplets are sitting as beads without spreading onto the surface, thereby indicating a high contact angle and a low surface energy, and surface homogeneity.

### Example 6

### Long-Term Exposure of LEAP Material

In Example 6, the effectiveness of the LEAP material for exposures of six months is demonstrated. LEAP-lined rods were continually exposed for 6 months (except for weekend shut down and shut down for maintenance) in FSU-1 (left of FIG. 27) and FSU-2 (right of FIG. 27). The LEAP is still effective in significantly reducing fouling.

Examples 1 to 4 demonstrated the effectiveness of small coupons (1.5 cm ID and 5.1 cm long) made out of the LEAP material in reducing fouling for an exposure of up to 144 hours. Example 5 demonstrated the effectiveness of a LEAP liner (13.3 to 14.0 cm long and 13.4 cm OD) in reducing fouling during up to 360 hours of exposure. In Example 4, the effectiveness of a LEAP coupon with the rougher surface was demonstrated for a 72-hour exposure. Example 6 shows that the surface of LEAP-lined rods is not affected after six months of continuous use (except for weekend shut down and shut down for maintenance) and that LEAP is still effective in significantly reducing fouling.

In summary, the above examples clearly show that while none of the conventional and state-of-the-art anti-fouling materials recommended by fouling experts was effective in significantly reducing fouling in the FSU fluid environment of the PFT process, the LEAP material performed remarkably and unexpectedly well.

The examples show that in a PFT fouling environment, a material with low and uniform surface energy and of relatively pure grade with limited additives to limit nucleation sites for fouling can be effective in reducing fouling. It is believed that it is because of these unique requirements that none of the state-of-the-art anti-fouling materials was effective while the LEAP was effective.

The use of a LEAP material may be applied to both low- and high-temperature PFT processes, covering a temperature range of, but not restricted to, 15 to 100° C.

While much of the above description refers to reduction of fouling on a surface of a vessel used in a PFT process, reduction of fouling on a surface of a conduit used in a PFT process is also in scope.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A fluorocarbon polymer as a surface of a vessel or conduit in a paraffinic froth treatment (PFT) process, for reducing fouling, the foulant comprising asphaltenes, wherein the surface has:
an average water contact angle of greater than 90 degrees;
a standard deviation of water contact angles divided by the average water contact angle of less than 0.1; and
impurities of less than 1000 ppmw.

2. The use according to claim 1, wherein the average water contact angle is greater than 100 degrees.

3. The use according to claim 1, wherein the average water contact angle is greater than 110 degrees.

4. The use according to claim 1, wherein the average water contact angle is greater than 115 degrees.

5. The use according to claim 1, wherein the standard deviation of water contact angles divided by the average water contact angle is less than 0.05.

6. The use according to claim 1, wherein the standard deviation of water contact angles divided by the average water contact angle is less than 0.03.

7. The use according to claim 1, wherein less than 100 ppmw impurities are present.

8. The use according to claim 1, wherein less than 10 ppmw impurities are present.

9. The use according to claim 1, wherein the fluorocarbon polymer comprises a polytetrafluoroethylene (PTFE)-based polymer, wherein a PTFE-based polymer is a homopolymer of TFE (tetrafluoroethylene) or a copolymer of TFE with one or more comonomers comprising at least one ethylene type unsaturation.

10. The use according to claim 9, wherein the comonomer content is less than 2 percent by weight.

11. The use according to claim 9, wherein comonomer content is less than 1 percent by weight.

12. The use according to claim 9, wherein the comonomers comprise: a C₃-C₈ perfluoroolefin; a C₂-C₈ chloro-; bromo- and/or iodo-fluoroolefin; a (per)fluoroalkylvinylether of formula CF₂═CFOR_{f}(PAVE), wherein R_{f} is a C₁-C₆ (per)fluoroalkyl, a (per)fluoro-oxyalkyvinylether of formula CF₂═CFOX, wherein X is a C₁-C₂ alkyl, a C₁-C₁₂ oxyalkyl, or a C₁-C₁₂ (per)fluoro-oxyalkyl having one or more ether groups.

13. The use according to claim 1, wherein the fluorocarbon polymer is PFA (perfluoroalkoxy), FEP (fluorinated ethylene propylene), ETFE (ethylene tetrafluoroethylene), ECTFE (ethylene chlorotrifluoroethylene), PVDF (polyvinylidene fluoride), or PCTFE (polychlorotrifluoroethylene).

14. The use according to claim 9, wherein the fluorocarbon polymer is a polymer in accordance with ASTM D 4894-98a of Type I, II, III, or IV.

15. The use according to claim 1, wherein the fluorocarbon polymer is a polymer in accordance with ASTM D 4894-98a, Type IV, Grade 2.

16. The use according to claim 1, wherein the fluorocarbon polymer is a polymer in accordance with ASTM D 4895-04.

17. The use according to claim 1, wherein the fluorocarbon polymer is a fluoroelastomer or a tetrafluoroelastomer.

18. The use according to claim 1, wherein the surface has a surface roughness of less than 0.5 μm.

19. The use according to claim 1, wherein the surface is substantially free of colorants, fillers, and plasticizers.

20. The use according to claim 1, wherein the fluorocarbon polymer is affixed to, adhered to, abutted against, or mated with, an inside of the vessel or conduit.

21. The use according to claim 1, wherein the fluorocarbon polymer is made by isostatic molding.

22. The use according to claim 1, wherein the foulant comprises water, paraffinic solvent, inorganics, and non-volatile hydrocarbons comprising asphaltenes.

23. The use according to claim 1, wherein the foulant comprises 5-80 percent water and paraffinic solvent, 1-80 percent inorganics, 1-90 percent non-volatile hydrocarbons comprising asphaltenes, all by weight.

24. The use according to claim 1, wherein the foulant comprises about 46-50 percent water and paraffinic solvent, about 24-46 percent inorganics, and about 14-26 percent non-volatile hydrocarbons comprising asphaltenes, all by weight.

25. The use according to claim 1, wherein the foulant comprises between 7 and 40 percent asphaltenes, by weight.

26. The use according to claim 23, wherein the inorganics comprise quartz, alumino-silicates, carbonates, FeₓS_{y}, where x is from 1 to 2 and y is from 1 to 3, and titanium-rich minerals.

27. The use according to claim 23, wherein a major amount by number of the inorganics is present in particulates of less than 1 μm in size.

28. The use according to claim 1, wherein the PFT process is a low- or high-temperature process, characterized by a temperature of 15 to 100° C.

29. The use according to claim 1, wherein the vessel is a froth separation unit (FSU) used in the PFT process.

30. The use according to claim 29, wherein the surface is a launder area of the FSU.

31. A process for creating a fouling reducing surface of a vessel or conduit for use in a paraffinic froth treatment (PFT) process, the foulant comprising asphaltenes, the process comprising:
forming a fluorocarbon polymer; and
at least partially covering an inside of the vessel or conduit with the formed polymer;
wherein the surface has: an average water contact angle of greater than 90 degrees; a standard deviation of water contact angles divided by the average water contact angle of less than 0.1; and impurities of less than 1000 ppmw.

32. The process according to claim 31, wherein the step of at least partially covering an inside of the vessel or conduit with the polymer comprises adhering or affixing the polymer to, or abutting the polymer against, the inside of the vessel of conduit.

33. The process according to claim 31, wherein the step of at least partially covering an inside of the vessel of conduit with the polymer comprises mating a plurality of pieces of polymer with mating members on the inside of the vessel of conduit.

34. The process according to claim 31, wherein the fluorocarbon polymer is formed by isostatic molding.

35. The process according to claim 31, wherein the
average water contact angle is greater than 110 degrees;
the standard deviation of water contact angles divided by the average water contact angle is less than 0.05;
less than 100 ppmw impurities are present; and
the fluorocarbon polymer comprises a polytetrafluoroethylene (PTFE)-based polymer, wherein a PTFE-based polymer is a homopolymer of TFE (tetrafluoroethylene) or a copolymer of TFE with one or more comonomers comprising at least one ethylene type unsaturation, wherein comonomer content is less than 1 percent by weight.

36. The process according to claim 31, wherein the
the average water contact angle is greater than 110 degrees;
the standard deviation of water contact angles divided by the average water contact angle is less than 0.05;
less than 100 ppmw impurities are present; and
the fluorocarbon polymer is PFA (perfluoroalkoxy), FEP (fluorinated ethylene propylene), ETFE (ethylene tetrafluoroethylene), ECTFE (ethylene chlorotrifluoroethylene), PVDF (polyvinylidene fluoride), or PCTFE (polychlorotrifluoroethylene).

37. The process according to claim 31, wherein the surface is substantially free of colorants, fillers, and plasticizers.

38. The process according to claim 31, wherein the foulant comprises 5-80 percent water and paraffinic solvent, 1-80 percent inorganics, 1-90 percent non-volatile hydrocarbons comprising asphaltenes, all by weight.
